(19) United States
(12) Patent Application Publication
(10) Pub. No.: US 2011/0185145 A1
(43) Pub. Date: Jul. 28, 2011

(54) SEMICONDUCTOR STORAGE DEVICE AND CONTROL METHOD THEREOF

(75) Inventor: Hiroyuki Moro, Fussa-shi (JP)

(73) Assignee: KABUSHIKI KAISHA TOSHIBA, Tokyo (JP)

(21) Appl. No.: 13/013,674

(22) Filed: Jan. 25, 2011

(30) Foreign Application Priority Data
Jan. 27, 2010 (JP) 2010-015948

(51) Int. Cl. G06F 12/00

(52) U.S. Cl. 711/167; 711/E12.001

(57) ABSTRACT

According to one embodiment, a semiconductor storage device comprises nonvolatile memories, memory controllers connected to the nonvolatile memories, and an arbitration module. The arbitration module is configured to control a timing of permitting one of operations of program, erase, and read of the memory controllers.

### CROSS-REFERENCE TO RELATED APPLICATIONS

This application is based upon and claims the benefit of priority from Japanese Patent Application No. 2010-015948, filed Jan. 27, 2010; the entire contents of which are incorporated herein by reference.

### FIELD

Embodiments described herein relate generally to a semiconductor storage device including nonvolatile memories and a control method of a semiconductor storage device.

### BACKGROUND

A conventional example of a semiconductor storage device is described in Jpn. Pat. Appln. KOKAI Publication No. 2002-351737. The semiconductor storage device includes nonvolatile memories and is capable of operating with plural power-supply voltages. The semiconductor storage device further includes a host interface circuit configured to carry out data input/output between the device and a host system. The host interface circuit includes plural buffers to be utilized for inputting/outputting data. In data writing, the data is transferred from the host system to the buffer through the host interface circuit. Thereafter, the data in the buffer is decoded by an ECC circuit, and is written to a nonvolatile memory. The data transfer time is determined by an operating frequency of the clock. When the operating frequency is high, although the processing is carried out at high speed, the consumption current increases. Further, by alternately using the plural buffers, data transfer rate can also be enhanced. By apportioning write data to plural memories, it is possible to carry out simultaneous writing, and shorten the processing time. As the number of the nonvolatile memories of simultaneous operation increases, the operating current increases.

Plural upper limits of consumption currents exist for plural power-supply voltages. The higher the power-supply voltage, the higher the consumption current upper limit setting. Accordingly, in the semiconductor storage device of Jpn. Pat. Appln. KOKAI Publication No. 2002-351737, in order to make the device exhibit the optimum performance within the maximum permissible consumption current corresponding to the voltage which is selected from the plural power-supply voltages and is input to the semiconductor storage device, the input voltage input to the semiconductor storage device is detected from the plural power-supply voltages and the maximum permissible current is set based on the detected power-supply voltage. The number of simultaneously operated nonvolatile memories or the operating frequency of the internal clock is controlled in such a manner that the consumption current of the semiconductor storage device does not exceed the maximum permissible consumption current.

As described above, in the semiconductor storage device described in Jpn. Pat. Appln. KOKAI Publication No. 2002-351737, it is possible to control the number of simultaneously operated plural nonvolatile memories or the operating frequency of the internal clock. However, in the nonvolatile memory, the consumption current differs according to the various operation modes such as program, erase, read, and the like. Therefore, it is not possible to make the device exhibit the optimum performance by simply controlling the number of simultaneously operated memories or the operating frequency of the internal clock.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view of a semiconductor storage device according to an embodiment.

FIG. 2 is an exemplary timing chart showing a fundamental write operation of a NAND flash memory according to the embodiment.

FIG. 3 is an exemplary flowchart showing an example of an operation of an arbitration module of the semiconductor storage device according to the embodiment.

FIG. 4 is an exemplary timing chart showing an example of the operation of the arbitration module of the semiconductor storage device according to the embodiment.

FIG. 5 is an exemplary timing chart showing an example of the operation of the arbitration module of the semiconductor storage device according to the embodiment.

FIG. 6 is an exemplary flowchart showing another example of the operation of the arbitration module of the semiconductor storage device according to the embodiment.

FIG. 7 is an exemplary timing chart showing another example of the operation of the arbitration module of the semiconductor storage device according to the embodiment.

FIG. 8 is an exemplary timing chart showing another example of the operation of the arbitration module of the semiconductor storage device according to the embodiment.

### DETAILED DESCRIPTION

Various embodiments will be described hereinafter with reference to the accompanying drawings.

In general, according to one embodiment, a semiconductor storage device comprises nonvolatile memories, memory controllers connected to the nonvolatile memories, and an arbitration module. The arbitration module is configured to control a timing of permitting one of operations of program, erase, and read of the memory controllers.

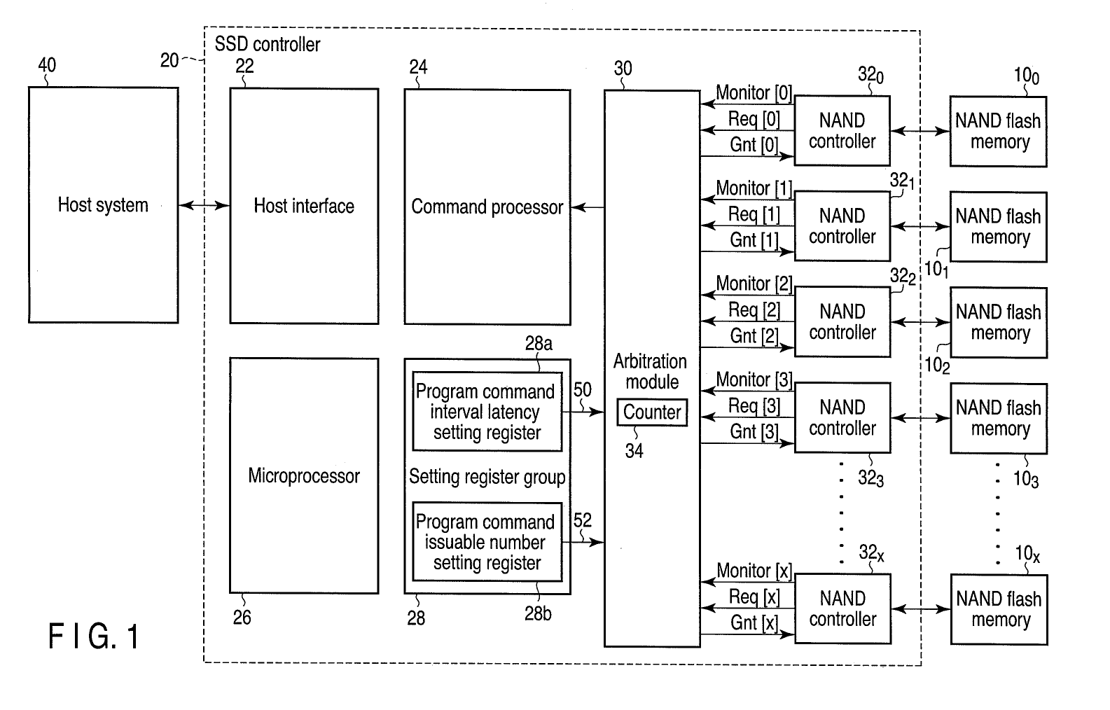

FIG. 1 is an exemplary view showing the overall configuration of a semiconductor storage device of a first embodiment. A solid-state drive (SSD) will be described below as an example. The semiconductor storage device includes plural semiconductor nonvolatile memories constituting a storage section of the SSD, for example, NAND flash memories 10₀, 10₁, . . . , 10ₓ. Each of the flash memories 10₀, 10₁, . . . , 10ₓ is constituted of, for example, 2 to 16 memory chips. The flash memories 10₀, 10₁, . . . , 10ₓ are connected to an SSD controller 20. The SSD controller 20 includes a host interface 22 connected to a host system 40, and NAND controllers 32₀, 32₁, . . . , 32ₓ connected to the flash memories 10₀, 10₁, . . . , 10ₓ.

Each of the NAND controllers 32₀, 32₁, . . . , 32ₓ separately controls each of the flash memories 10₀, 10₁, . . . , 10ₓ with respect to the operation modes such as program, read, erase, and the like. The NAND controllers 32₀, 32₁, . . . , 32ₓ are connected to an arbitration module 30. The arbitration module receives an issuance permission request Req of a program command from each of the NAND controllers 32₀, 32₁, . . . , 32ₓ and, when the issuance can be permitted, transmits permission Gnt for issuance of the program command to each of the NAND controllers 32₀, 32₁, . . . , 32ₓ. Each of the NAND controllers 32₀, 32₁, . . . , 32ₓ cannot issue a program command to the corresponding one of the flash memories 10₀, 10₁, . . . , 10ₓ without receiving the program command issuance permission Gnt. A supervisory signal Monitor of an R/B# signal of the flash memory can also be transmitted from each of the NAND controllers 32₀, 32₁, . . . , 32ₓ to the arbitration module 30.

The SSD controller also includes a command processor 24, microprocessor 26, and setting register group 28. The host interface 22, command processor 24, setting register group 28, and arbitration module 30 are connected to a system bus of the microprocessor 26, although the connection is not shown. The arbitration module 30 is connected to the command processor 24, and setting register group 28. The setting register group 28 may include, for example, a program command interval latency setting register 28a, and program command issuable number setting register 28b. Values indicating an interval latency time and an issuable number are set by the microprocessor 26 to these registers 28a and 28b. The arbitration module 30 includes a counter 34 configured to measure the issuance interval of the program command.

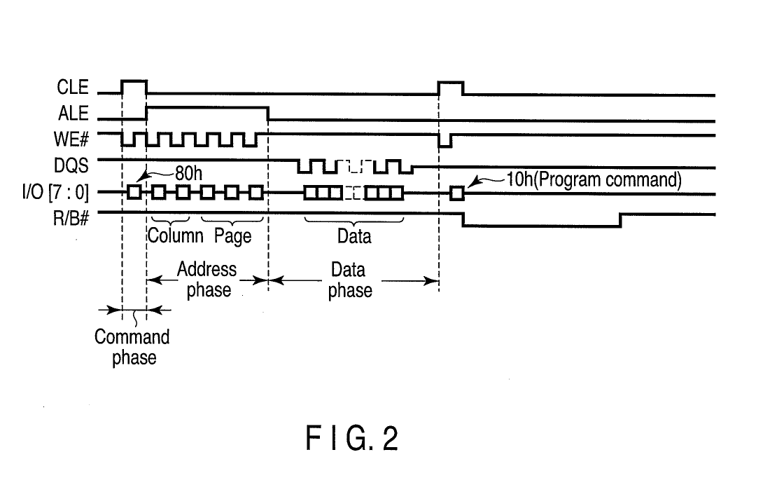

An operation of the embodiment will be described below. First, an operation of the NAND flash memory will be described. FIG. 2 is a timing chart of the NAND controller 32 for showing the fundamental program (write) operation of the NAND flash memory 10 corresponding to a toggle mode.

When data is written to the NAND flash memory 10, first, “80h” indicating data input to a buffer of the NAND flash memory 10 is output to an 8-bit I/O signal in a state where a Command Latch Enable (CLE) signal is asserted, and a Write Enable (WE)# signal is asserted. The data of the I/O signal is fetched in the NAND flash memory 10 on the rising edge of the WE signal (this period is called a command phase).

Then, in a state where an Address Latch Enable (ALE) signal is asserted, a column address and page address are output to the I/O signal a necessary number of times together with the WE signal. The data of the I/O signal is fetched in the NAND flash memory 10 on the rising edge of the WE signal like in the command phase (this period is called an address phase).

The column address and page address are different from each other in the number of required bytes depending on the size of the NAND flash memory 10. After the completion of the address phase, the data is transferred to a buffer (not shown) of the NAND flash memory 10 (this is called a data phase). In the data phase, the data of the I/O signal is fetched in the NAND flash memory 10 on both the rising edge and falling edge of a data strobe (DQS) signal. When transfer of data desired to be written to the NAND flash memory 10 is completed, finally, in a state where the CLE signal is asserted, “10h” (program command) instructing to carry out write from the buffer of the NAND flash memory 10 to the I/O signal is output, and the WE signal is asserted.

Upon receipt of the program command, the NAND flash memory 10 carries out actual write (write from the buffer to the memory cell) to the memory cell and, during the write operation, a Ready/Busy (R/B#) signal is made low, thereby indicating that the state is Busy. In the program operation of the NAND flash memory 10, the power consumption becomes greatest in the Busy period in which actual write to the memory cell is carried out. The Busy period is started from the issuance of the program command. Therefore, by controlling the issuance of the program command, it is possible to control the power consumption in the program operation.

An operation of the arbitration module 30 configured to control the issuance of the program command will be described below. In this example, the issuance interval of the program command or the number of simultaneously issuable program commands is controlled.

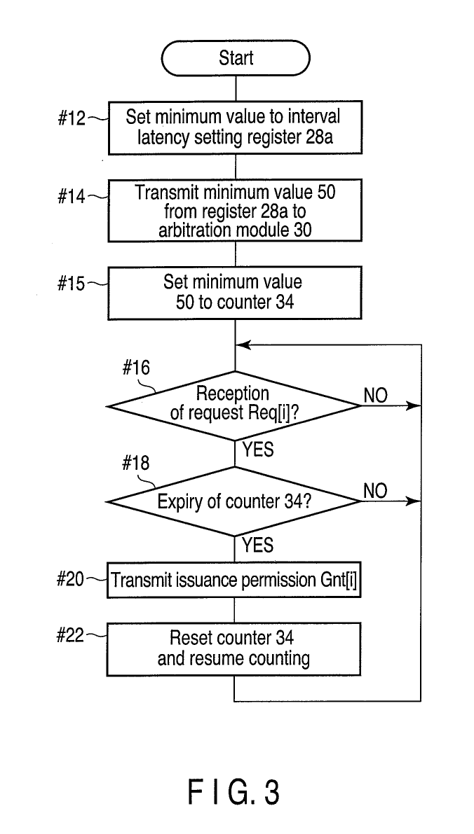

First, an operation of the arbitration module 30 configured to control the issuance interval of the program command will be described with reference to FIG. 3. A value used to set the minimum value of a time interval from issuance of a certain program command to issuance of the next program command is set to the program command interval latency setting register 28a by the microprocessor 26 (block #12). A program command interval minimum value 50 is supplied from the program command interval latency setting register 28a to the arbitration module 30 (block #14).

Each of the NAND controllers 32₀, 32₁, . . . , 32ₓ manages input/output of an interface signal between itself and the corresponding one of the NAND flash memories 10₀, 10₁, . . . , 10ₓ, and control of the issuance timing of a program command is also under the control thereof.

In block #15, the counter 34 is initialized. Here, a program command interval minimum value 50 is set to the counter 34 as an initial value.

The arbitration module 30 determines in block #16 whether or not a program command issuance permission request Req has been transmitted from any one of the NAND controllers 32₀, 32₁, . . . , 32ₓ. Block #16 is repeated until an issuance permission request Req is transmitted. Upon receipt of a program command issuance permission request Req[i] from any one (assumed to be 32i) of the NAND controllers 32₀, 32₁, . . . , 32ₓ, the arbitration module 30 determines in block #18 whether or not the counter 34 configured to measure the program command issuance interval has expired. The counter 34 expires when it counts up to the program command interval minimum value 50. In block #15, the program command interval minimum value 50 has been set as the initial value. Therefore, in the first determination in block #18, it is determined that the counter 34 has expired.

When the counter 34 has expired, issuance permission Gnt[i] is given to NAND controller 32ᵢ that has transmitted the program command issuance permission request Req to the arbitration module 30 (block #20). When the counter 34 is counting, and has not expired yet, giving of the program command issuance permission Gnt[i] is postponed until the counter expires.

When, in block #16, program command issuance permission requests Req are received from the NAND controllers 32₀, 32₁, . . . , 32ₓ, and transmission of issuance permission Gnt items is on standby, issuance permission Gnt items are given in block #20 in the order in which the requests Req have been received. When the program command issuance permission Gnt is given to any one of the NAND controllers 32₀, 32₁, . . . , 32ₓ, the counter 34 is reset in block #22, and thereafter the counter 34 resumes counting.

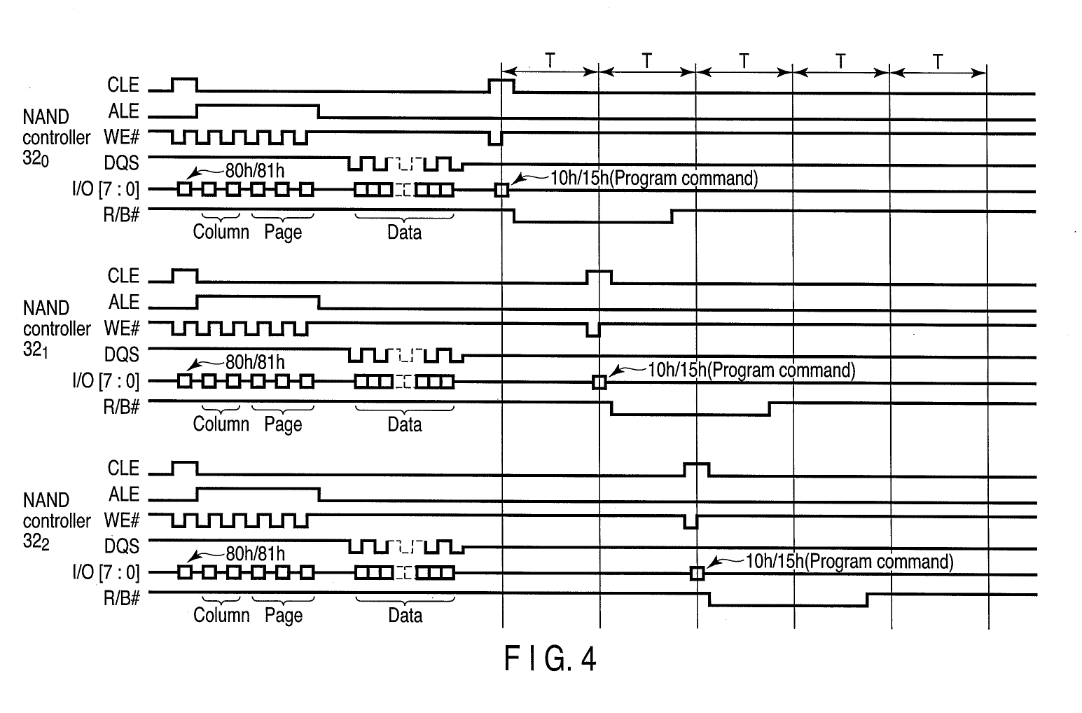

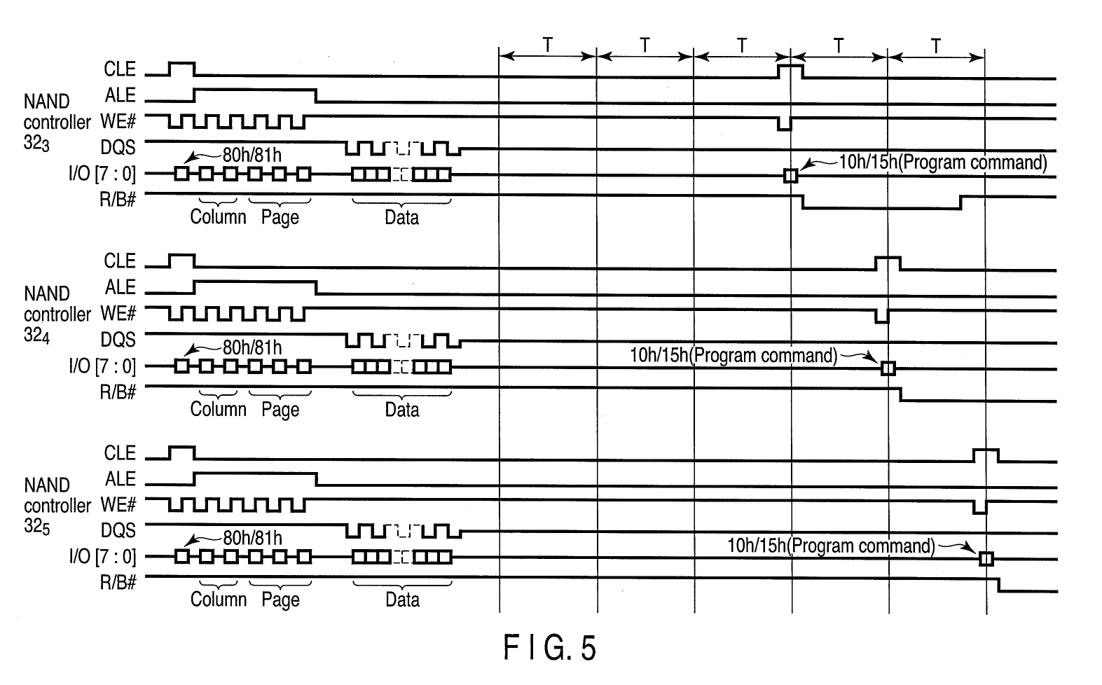

FIGS. 4 and 5 are timing charts showing operations of six NAND controllers 32₀, 32₁, 32₂, 32₃, 32₄, and 32₅ in the case where a program command interval minimum value T is set to the program command interval latency setting register 28a.

Assuming that the arbitration module 30 has received program command issuance permission requests Req from NAND controllers 32₀, 32₁, 32₂, 32₃, 32₄, and 32₅ in the order mentioned, the output of the program command issuance permission Gnt items for NAND controllers 32₀ to 32₅ has a time span of T even if the issuance permission requests are received within a period shorter than T or simultaneously. As a result, according to this embodiment, the start timing of the Busy period (period in which actual write to the memory cell is carried out) in which the power consumption becomes greatest in the program operation of the NAND flash memory 10 is shifted. Therefore, it is possible to prevent the power consumption in the program operation from increasing. The program command issuance interval minimum value T corresponds to the value set by the microprocessor 26. Therefore, it is possible to make the device exhibit the optimum performance corresponding to the operating environment at all times by varying the set value in such a manner that the value becomes an appropriate value in accordance with various operating conditions of the device.

It should be noted that although the program command issuance interval minimum value has been set in the embodiment, in addition to this or in place of this, an issuance interval minimum value of an erase command or a read command may be set. By such a modification example too, it is possible to prevent operations of the NAND flash memory 10, the operations each involving large power consumption, from occurring simultaneously, and hold the maximum power consumption in the semiconductor storage device in which plural NAND flash memories are incorporated down to a small amount.

Furthermore, although in the operation described above, the issuance interval of the command has been controlled, the present invention is not limited to this and, in a device in which plural commands can be simultaneously issued, it is also possible to control the number of commands to be issued.

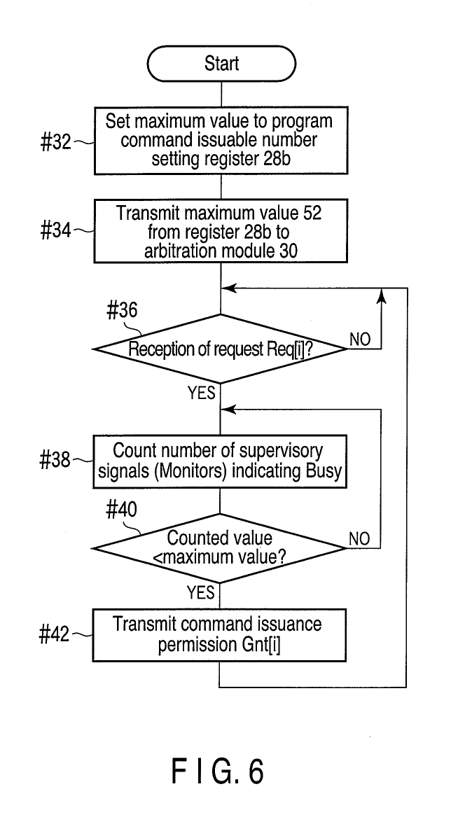

An operation of the arbitration module 30 configured to control the number of commands to be issued will be described below with reference to FIG. 6. A value for setting the maximum allowable number of program commands simultaneously issued in the system is set to the program command issuable number setting register 28b by the microprocessor 26 (block #32). A program command maximum issuable number 52 is supplied from the program command issuable number setting register 28b to the arbitration module 30 (block #34).

The arbitration module 30 determines in block #36 whether or not a program command issuance permission request Req has been transmitted from any one of the NAND controllers 32₀, 32₁, . . . , 32ₓ. Block #36 is repeated until an issuance permission request Req is transmitted. Upon receipt of a program command issuance permission request Req[i] from any one (assumed to be 32i) of the NAND controllers 32₀, 32₁, . . . , 32ₓ, the arbitration module 30 checks, in block #38, the supervisory signal Monitor of an R/B# signal from each of all the NAND controllers 32₀, 32₁, . . . , 32ₓ connected thereto, and obtains the number of supervisory signals “Monitors” of R/B# signals of which indicate Busy. The obtained number is compared with the program command maximum issuable number 52 in block #40.

When the number of supervisory signals “Monitors” indicating Busy is less than the program command maximum issuable number 52, issuance permission Gnt[i] is given, in block #42, to NAND controller 32ᵢ that has transmitted the program command issuance permission request Req to the arbitration module 30. When the number of supervisory signals “Monitors” indicating Busy is greater than or equal to the program command maximum issuable number 52, the operations of blocks #38 and #40 are repeated in order to postpone giving of the program command issuance permission Gnt until the number of supervisory signals “Monitors” indicating Busy becomes less than the program command maximum issuable number 52. When, in block #36, program command issuance permission requests Req are received from the plural NAND controllers 32₀, 32₁, . . . , 32ₓ, and transmission of a plurality of issuance permission Gnt items is on standby, issuance permission Gnt items are given in block #42 in the order in which the requests Req have been received.

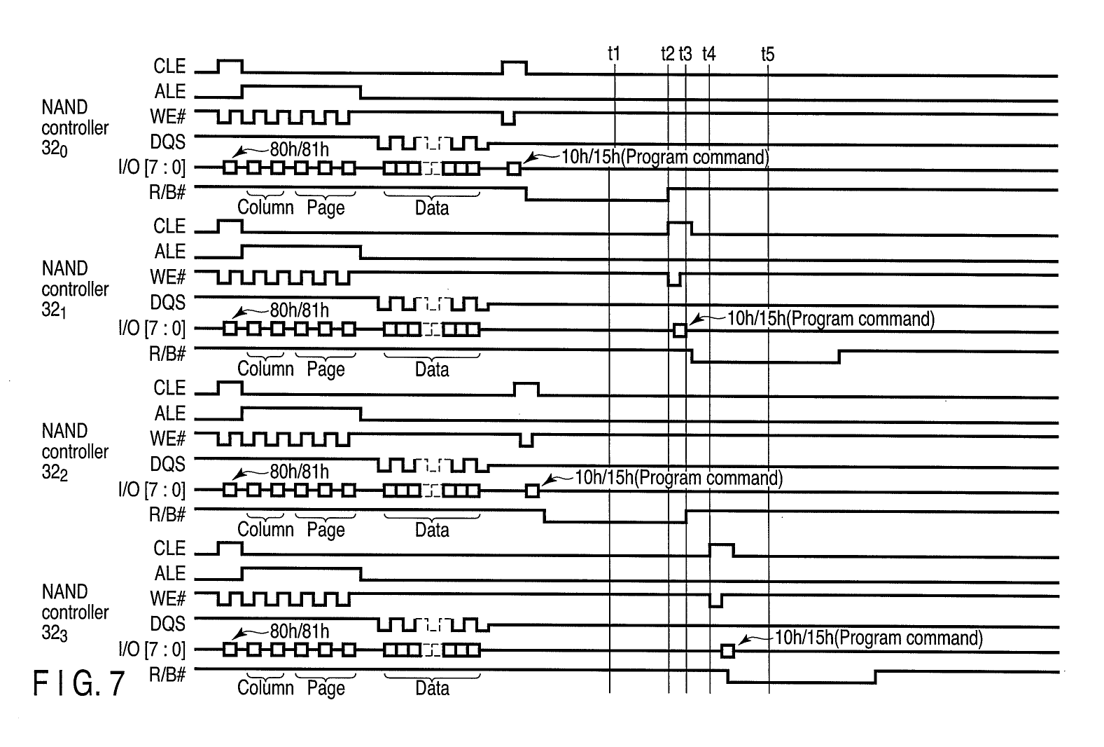

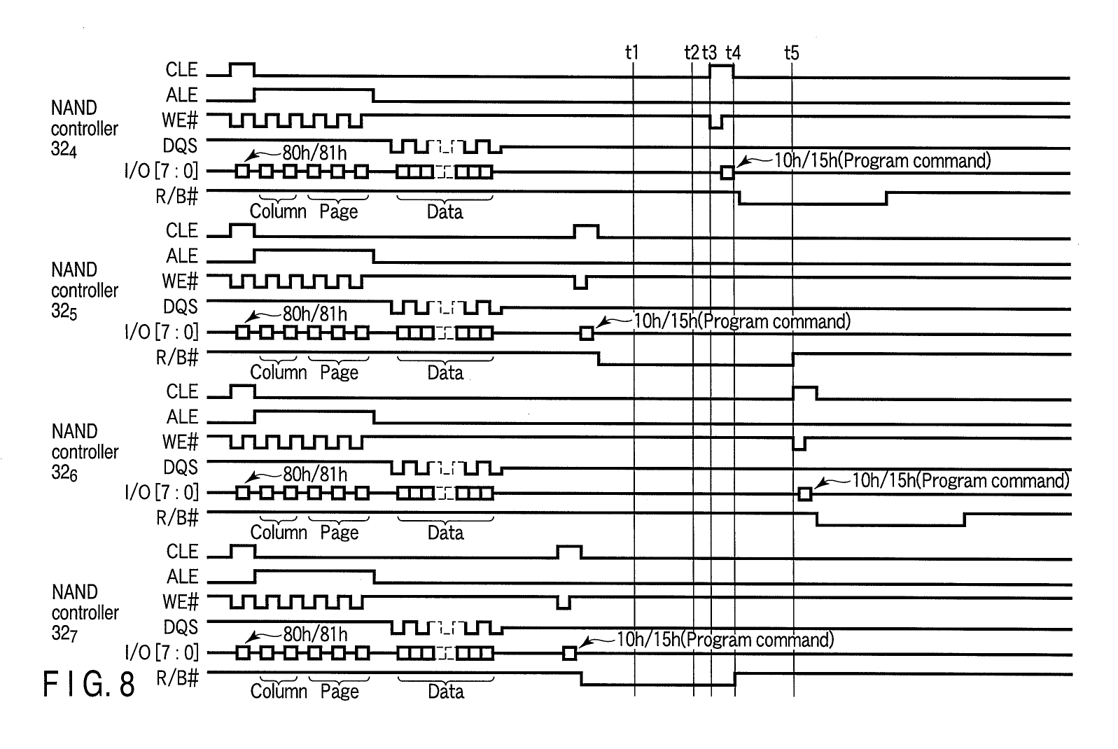

FIGS. 7 and 8 are timing charts of a case where eight NAND controllers 32₀, 32₁, 32₂, 32₃, 32₄, 32₅, 32₆, and 32₇ are connected to the arbitration module 30, a maximum number 4 is set to the program command issuable number setting register 28b, and program command issuance permission requests have been transmitted from NAND controller 32₀, NAND controller 32₂, NAND controller 32₇, NAND controller 32₅, NAND controller 32₁, NAND controller 32₄, NAND controller 32₃, and NAND controller 32₆ in the order mentioned to the arbitration module.

The arbitration module 30 gives program command issuance permission items in the order in which the program command issuance permission requests have been received. Therefore, the value (4 in this case) set to the program command issuable number setting register 28b becomes equal to the number of supervisory signals “Monitors” of R/B# signals of which indicate Busy at the point (timing t1) in time at which NAND controller 32₀, NAND controller 32₂, NAND controller 32₇, and up to NAND controller 32₅ have issued program commands. After this, until the point (timing t2) in time at which a supervisory signal Monitor of an R/B# signal output from any one of the above-mentioned four NAND controllers stops indicating Busy, NAND controller 32₁ that has next transmitted the issuance request cannot receive issuance permission, and cannot issue a program command.

At timing t2, the supervisory signal Monitor of the R/B# signal of NAND controller 32₀ has stopped indicating Busy. Therefore, program command issuance permission is given to NAND controller 32₁ that has transmitted an issuance permission request to the arbitration module 30 next to NAND controller 32₅. When NAND controller 32₁ issues a program command, the maximum number set to the program command issuable number setting register 28b, and number of supervisory signals “Monitors” of R/B# signals of which indicate Busy become equal to each other again. Therefore, NAND controller 32₄ has to wait until an R/B# signal of any one of the NAND controllers 32₁ to 32₇ stops indicating Busy.

At timing t3, the R/B# signal of NAND controller 32₂ becomes not Busy. Therefore, it becomes possible for NAND controller 32₄ to obtain program command issuance permission. Likewise, NAND controller 32₃ has to wait for the program command issuance until timing t4, and NAND controller 32₆ has to wait for the program command issuance until timing t5.

As described above, even when the arbitration module 30 has received program command issuance permission requests Req from the NAND controllers 32₀, 32₁, 32₂, 32₃, 32₄, and 32₅, the circuit 30 does not transmit the program command issuance permission Gnt to NAND controllers 32 of a number exceeding the maximum number set to the program command issuable number setting register 28b. Therefore, the number of Busy periods (periods in each of which actual write to the memory cell is carried out) in each of which the power consumption becomes greatest in the program operation of the NAND flash memory 10 overlapping each other is limited, whereby it is possible to prevent the power consumption in the program operation from increasing. The maximum number of the number of simultaneously issuable program commands corresponds to the value set by the microprocessor 26. Therefore, it is possible to make the device exert the optimum performance corresponding to the operating environment at all times by varying the set value in such a manner that the value becomes an appropriate value in accordance with various operating conditions of the device.

It should be noted that although the maximum number of program commands simultaneously issued has been set in the embodiment, in addition to this or in place of this, the maximum number of erase commands or read commands simultaneously issued may be set. By such a modification example too, it is possible to prevent operations of the NAND flash memory 10, the operations each involving large power consumption, from occurring simultaneously, and hold the maximum power consumption in the semiconductor storage device in which the NAND flash memories are incorporated down to a small amount.

According to the embodiment, it is possible to spread the operation periods of program, erase, and read in each of which the power consumption of the nonvolatile memory becomes large. Therefore, it is possible to provide a semiconductor storage device capable of exerting the optimum performance at predetermined power consumption.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A semiconductor storage device comprising:
a plurality of nonvolatile memories;
a plurality of memory controllers connected to the nonvolatile memories; and
an arbitration controller configured to control the timing of permission grants for memory controller operations, wherein the memory controller operations each comprise one of a program operation, an erase operation, and a read operation.

2. The device of claim 1, wherein
the arbitration controller is configured to adjust an interval at which program command issuance permission requests from the memory controllers are granted in such a manner that an interval at which program commands are issued from the memory controllers to the nonvolatile memories is greater than a predetermined interval.

3. The device of claim 1, wherein
the arbitration controller is configured to adjust an interval at which erase command issuance permission requests from the memory controllers are granted in such a manner that an interval at which erase commands are issued from the memory controllers to the nonvolatile memories is greater than a predetermined interval.

4. The device of claim 1, wherein
the arbitration controller is configured to adjust an interval at which read command issuance permission requests from the memory controllers are granted in such a manner that an interval at which read commands are issued from the memory controllers to the nonvolatile memories is greater than a predetermined interval.

5. The device of claim 1, wherein
the arbitration controller is configured to limit the number of program command issuance permission requests that are concurrently granted in such a manner that the number of program commands concurrently issued from the memory controllers to the nonvolatile memories is less than a predetermined value.

6. The device of claim 1, wherein
the arbitration controller is configured to limit the number of erase command issuance permission requests that are concurrently granted in such a manner that the number of erase commands concurrently issued from the memory controllers to the nonvolatile memories is less than a predetermined value.

7. The device of claim 1, wherein
the arbitration module is configured to limit the number of read command issuance permission requests that are concurrently granted in such a manner that the number of read commands concurrently issued from the memory controllers to the nonvolatile memories is less than a predetermined value.

8. A method of controlling a semiconductor storage device comprising a plurality of nonvolatile memories, and a plurality of memory controllers connected to the nonvolatile memories, the method comprising:
controlling the timing permission grants for memory controller operations, wherein the memory controller operations each comprise one of a program operation, an erase operation, and a read operation.

9. The method of claim 8, wherein controlling comprises adjusting an interval at which program command issuance permission requests from the memory controllers are granted in such a manner that an interval at which program commands are issued from the memory controllers to the nonvolatile memories is greater than a predetermined interval.

10. The method of claim 8, wherein controlling comprises adjusting an interval at which erase command issuance permission requests from the memory controllers are granted in such a manner that an interval at which erase commands are issued from the memory controllers to the nonvolatile memories is greater than a predetermined interval.

11. The method of claim 8, wherein controlling comprises adjusting an interval at which read command issuance permission requests from the memory controllers are granted in such a manner that an interval at which read commands are issued from the memory controllers to the nonvolatile memories is greater than a predetermined interval.

12. The method of claim 8, wherein controlling comprises limiting the number of program command issuance permission requests that are concurrently granted in such a manner that the number of program commands concurrently issued from the memory controllers to the nonvolatile memories is less than a predetermined value.

13. The method of claim 8, wherein controlling comprises limiting the number of erase command issuance permission requests that are concurrently granted in such a manner that the number of erase commands concurrently issued from the memory controllers to the nonvolatile memories is less than a predetermined value.

14. The method of claim 8, wherein controlling comprises limiting the number of read command issuance permission requests that are concurrently granted in such a manner that the number of read commands concurrently issued from the memory controllers to the nonvolatile memories is less than a predetermined value.
